(19) United States
(12) Patent Application Publication
(10) Pub. No.: US 2014/0170344 A1
(43) Pub. Date: Jun. 19, 2014

(54) MULTI-LAYER SHEET STRUCTURE HAVING MOISTURE BARRIER PROPERTIES

(71) Applicant: SPARTECH CORPORATION, St. Louis, MO (US)

(72) Inventors: Pranabes K. Pramanik, Bridgeton, MO (US); Gregory M. Dixon, Foristel, MO (US)

(73) Assignee: SPARTECH CORPORATION, St. Louis, MO (US)

(21) Appl. No.: 13/769,477

(22) Filed: Feb. 18, 2013

Related U.S. Application Data
(60) Provisional application No. 61/738,709, filed on Dec. 18, 2012.

(51) Int. Cl. B32B 27/08; B32B 1/02; B32B 15/085

(52) U.S. Cl. CPC B32B 27/08; B32B 15/085; B32B 1/02
USPC 428/34.5; 428/483; 428/451; 428/430; 428/475.2; 428/458; 428/36.6; 428/34.7; 428/35.9; 264/173.13

(57) ABSTRACT

A multi-layer sheet structure is provided. The multi-layer sheet structure comprises at least one structural layer comprising high impact polystyrene and at least one moisture barrier layer comprising greater than about 30 percent cyclic olefin copolymer by weight of the at least one moisture barrier layer.

### BACKGROUND

The present invention relates generally to a multi-layer sheet structure having moisture barrier properties, a related method of making the multi-layer sheet structure, and containers formed from the multi-layer sheet structure.

At least some known packaging containers are constructed from multiple layers of a variety of polymeric materials. The packaging containers formed therefrom may be used to store food, beverages, and pharmaceuticals, for example. One suitable polymeric material that may be used to form packaging containers is polystyrene. Polystyrene (PS) is a thermoplastic polymer that may be molded and/or extruded into sheet form and subsequently thermoformed into a variety of predetermined shapes and sizes, and provides a suitable rigid structure for storing products therein. While PS provides a rigid structure for storing products therein, it is susceptible to brittle fracture under impact. For instance, the PS may fracture into a plurality of shards under impact, such as from puncturing in some food processing applications.

Some prior art packaging containers use high-impact polystyrene (HIPS) for the structural component. HIPS generally has good impact resistance, machinability, and dimensional stability, which is desirable for certain applications. Under impact and/or puncture, HIPS generally stretches before puncture thereby resisting fracture. HIPS has been used in packaging containers including single serve brewing cups and containers containing various beverages such as coffee, tea, cocoa, chocolate, apple cider and powdered drinks. Problematically, containers formed from HIPS are generally unable to prevent the permeation of gas and moisture therethrough, which may lead to spoiling of the package contents.

One known method of preventing the permeation of gas through an article is to incorporate a layer of polymeric material having gas barrier properties with the package material. For example, some materials have oxygen barrier properties that minimize oxygen transmission rate. The oxygen transmission rate is the measurement of the amount of oxygen that passes through a material over a given period.

While oxygen barrier material generally impedes the permeation of oxygen therethrough, oxygen barrier material generally has limited moisture barrier properties. Many products are moisture-sensitive and water ingress can cause spoilage. Thus, the poor moisture barrier properties of PS limits its use in containers and cups for many food packaging applications.

Therefore, a need exists for improvements in multi-layer sheet structures to include layers of polymeric materials that have moisture barrier and oxygen barrier properties to facilitate maintaining the freshness of package contents, and to include layers of polymeric materials that may be punctured without non-brittle fracture to meet specific application guidelines.

### BRIEF DESCRIPTION

In one aspect, a multi-layer sheet structure is provided. The multi-layer sheet structure comprises at least one structural layer comprising high impact polystyrene and at least one moisture barrier layer comprising greater than about 30 percent cyclic olefin copolymer by weight of the at least one moisture barrier layer.

In another aspect, a container comprising a side wall, a bottom wall coupled to the side wall, and an open end opposite the bottom wall is provided. The container is formed from a multi-layer sheet structure and comprises at least one structural layer that comprises high impact polystyrene and at least one moisture barrier layer comprising greater than about 30 percent cyclic olefin copolymer by weight of said at least one moisture barrier layer.

In yet another aspect, a method of making a multi-layer sheet structure is provided. The method comprises feeding a plurality of thermoplastic materials to a plurality of extruders and co-extruding the plurality of thermoplastic materials from the plurality of extruders to form a plurality of layers. The plurality of layers comprises at least one structural layer that comprises high impact polystyrene and at least one moisture barrier layer that comprises greater about 30 percent cyclic olefin copolymer by weight of the at least one moisture barrier layer.

### BRIEF DESCRIPTION OF THE DRAWINGS

FIG. 1 is a sectional schematic view of an exemplary multi-layer sheet structure.

FIG. 2 is a perspective view of an exemplary container formed from the multi-layer sheet structure.

FIG. 3 is a side view of the container shown in FIG. 2.

### DETAILED DESCRIPTION

The present invention generally provides for a multi-layer sheet structure. The present invention also provides for a container comprising a side wall, a bottom wall coupled to the side wall, and an open end opposite the bottom wall, wherein the container is formed from a multi-layer sheet structure. The present invention yet further provides for a method of making a multi-layer sheet structure.

In the various embodiments of the present invention, the multi-layer sheet structure comprises at least one structural layer comprising high impact polystyrene, and at least one moisture barrier layer comprising cyclic olefin copolymer. The at least one structural layer provides the structure and rigidity for an article and/or package to be formed, and the at least one moisture barrier layer facilitates preventing the passage of moisture therethrough.

Optionally, the multi-layer sheet structure may further comprise at least one of an oxygen barrier layer, a polyolefin layer, and reinforcing agents (fillers) within any of the various layers of the multi-layer sheet structure. Oxygen barrier layers reduce the oxygen transmission rate through the multi-layer sheet structure, polyolefin layers provide stiffness and mechanical performance to the multi-layer sheet structure, tie layers provide adhesion between layers of dissimilar material, and reinforcing agents facilitate improving mechanical properties and increasing moisture/oxygen barrier properties of the structure.

In some embodiments, the multi-layer sheet structure may be used in forming various articles such as cups and cup shaped containers. The multi-layer sheet structure can be molded into the various articles using methods known in the art including, but not limited to, pressure forming, thermoforming, plug assisted thermoforming, thermal stamping, vacuum forming, compression forming, and the like. In one embodiment, it has been found that the multi-layer sheet structure may be formed into a single serve brewing cup that contains a food product or beverage concentrate such as coffee, tea, cocoa, chocolate, apple cider, or powdered drinks. In such embodiments, the structural layer is typically the outermost layer and is exposed to the environment and the moisture barrier layer or polyolefin layer is typically the innermost layer that is in direct contact with the contained food or beverage product. For example, and without limitation, the single serve brewing cup may be formed into the shape of a cup such as those used in brewing machines. In such embodiments, a quantity of product (typically in the form of a powder or granule) is placed in the single serve container, and the container is sealed with foil or any other suitable material to produce a finished product for ultimate consumption. In some embodiments, the container may also include filler paper that separates the quantity of product from the container. Upon use, the container is then placed in a brewing machine whereupon the container is punctured and hot water is added to reconstitute the contents of the container and form a liquid beverage or food product. The beverage or food product is then dispensed into any suitable cup or mug.

Because the container is in direct contact with the contents therein, the polymeric materials used for single serve brewing cups preferably meet certain guidelines to facilitate preventing contamination of the package contents during container puncture, and to properly dispense beverages therefrom. For example, the polymers of the multi-layer sheet structure may be FDA approved, and the polymeric material generally should not be susceptible to brittle fracture such that polymer debris from the container does not contaminate the package contents. Further, the container is designed meet certain cup puncture characteristics such as a targeted puncture force required to pierce the container, and the depth of a piercing unit into the container wall before puncture.

As mentioned above, in some embodiments, layers of the multi-layer sheet structure may comprise reinforcing agents such as an inorganic reinforcing agent (IRA). It has been found that by including IRA within layers of the multi-layer sheet structure, such as within the structural layer, cups formed therefrom have improved performance and sustainability. For instance, use of a reinforcing agent in the structural layer provides for the need for less polymer loading while maintaining the structural characteristics of the container. Containers formed from multi-layer sheets having reduced polymer loading result in a smaller carbon footprint and require less heating/melting energy when compared to known polystyrene-based cups. Further, using reinforcing agents facilitates improving the stiffness and mechanical performance of the multi-layer sheet structure. Accordingly, less material may be used to form IRA reinforced articles by down-gauging the thickness of the multi-layer sheet structure, thereby reducing materials costs.

As such, embodiments of the present invention provide for a multi-layer sheet structure having moisture and oxygen barrier properties, properties that meet and/or exceed puncture characteristics for known single serve brewing cups, increased sustainability, and reduced costs.

### Structural Layer

The structural layer comprises a polymer component comprising at least one polymer. The structural layer of the multi-layered compositions may comprise any suitable PS that enables the multi-layer sheet structure to function as described herein. In some embodiments, the PS is selected from high impact polystyrene (HIPS), general purpose PS, and combinations thereof. As used herein, the term “general purpose PS” refers to amorphous PS (APS), crystalline polystyrene (CPS), and combinations thereof. For purposes of the present invention, “crystalline” is defined as a polymer having a degree of crystallinity of from about 10% to about 80% and encompasses semicrystalline isotactic PS and semicrystalline syndiotactic PS. Non-limiting examples of HIPS polymers include rubber modified polystyrene, styrene-butadiene copolymer (SBC), styrene ethylene butylene styrene (SEBS) copolymer, acrylonitrile-butadiene styrene (ABS), styrene isoprene styrene (SIS) copolymer, styrene ethylene-propylene styrene (SEPS), styrene ethylene-propylene (SEP) copolymer, styrene-acrylonitrile (SAN) resin, styrene maleic anhydride (SMA), and blends thereof

In some embodiments of the present invention, the polymer component of the structural layer comprises HIPS or consists essentially of HIPS. In some other embodiments of the present invention, the polymer component of the structural layer may comprise HIPS in combination with general purpose PS, or may consist essentially of HIPS in combination with general purpose PS. For example, in any of the various embodiments of the present invention, the HIPS concentration is from about 20 percent to about 100 percent, from about 30 percent to about 95 percent, from about 40 percent to about 90 percent, from about 50 percent to about 85 percent, from about 60 percent to about 80 percent, or from about 70 percent to about 75 percent by weight based on the weight of the polymer component of the structural layer. In some other embodiments, the general purpose PS concentration is from about 0 percent to about 80 percent, from about 1 percent to about 60 percent, from about 5 percent to about 50 percent, from about 7.5 percent to about 40 percent, from about 10 percent to about 30 percent, or from about 15 percent to about 25 percent by weight based on the weight of the polymer component of the structural layer.

Furthermore, in any of the various embodiments of the present invention, the weight ratio of HIPS to general purpose PS is from about 100:1 to about 1:1, from about 50:1 to about 1:1, from about 20:1 to about 1:1, from about 10:1 to about 1:1, from about 10:1 to about 2:1 from about 5:1 to about 1:1, from about 2:1 to about 1:1, about 1:1, from about 1:1 to about 2:1, from about 1:1 to about 3:1, or from about 1:1 to about 4:1.

In some embodiments, the structural layer may further comprise any suitable additives that enable the multi-layer sheet structure to function as described herein. Examples of suitable additives include, but are not limited to sheet regrind leftover from sheet extrusion and thermoforming of the thermoplastic polymer used to form the structural layer, a colorant, reinforcing agents, an anti-blocking agent, an anti-oxidant, a UV stabilizer, an anti-static agent, a flame retardant, an anti-microbial agent, a processing aid, a chemical foaming agent that facilitates reducing the density and adjusts the mechanical properties of the multi-layer sheet structure, and combinations thereof

In any of the various embodiments of the present invention, the regrind concentration is from about 0 percent to about 60 percent, from about 5 percent to about 50 percent, from about 10 percent to about 40 percent, from about 12.5 percent to about 30 percent, or from about 15 percent to about 25 percent by weight based on the weight of the structural layer. In some embodiments, the regrind concentration is about 20 percent by weight based on the weight of the structural layer.

In any of the various embodiments of the present invention, the colorant concentration is from about 0 percent to about 10 percent, from about 1 percent to about 10 percent, from about 2.5 percent to about 7.5 percent, or from about 3 percent to about 5 percent by weight based on the weight of the structural layer.

Non-limiting examples of suitable physical or chemical foaming agents include, but are not limited to, surfactants and blowing agents. Examples of suitable blowing agents include, but are not limited to, carbon dioxide, pentane, chlorofluorocarbons, baking powder, a combination of sodium bicarbonate and citric acid, hollow glass spheres, micro-balloons, azodicarbonamide, titanium hydride, isocyanates, and combinations thereof. In any of the various embodiments of the present invention, the foaming agent reduces the density of the structural layer by 0 percent, about 5 percent, about 10 percent, about 15 percent, about 20 percent, about 25 percent, about 30 percent, about 35 percent, about 40 percent, about 45 percent or about 50 percent, and ranges thereof, such as from 0 percent to about 50 percent, from about 10 percent to about 50 percent or from about 25 percent to about 50 percent. In any of the various embodiments of the present invention, the foaming agent concentration is from about 0.2 percent to about 3 percent by weight, from about 0.2 percent to about 2.5 percent, or from about 0.5 percent to about 2 percent by weight based on the weight of the structural layer. Accordingly, the including the foaming agent in such concentrations facilitates reducing the density of the structural layer by up to about 50 percent.

In some embodiments of the present invention, the structural layer may further comprise an organic or inorganic reinforcing agent (filler). It is believed, without being bound by any particular theory, that reinforcing agents facilitate creating a tortious path within layers of the multi-layer sheet structure for permeable molecules such as water and oxygen. As such, it has been found that containers formed from the multi-layer sheet structure comprising such fillers further inhibit moisture and/or oxygen permeation.

Non-limiting examples of suitable inorganic reinforcing agents (IRA) include talc, calcium carbonate, wollastonite, aragonite, mica, nanoclay, silica, glass fiber, and combinations thereof. In any of the various embodiments of the present invention, the IRA concentration is no more than about 70 percent, from about 5 percent to about 60 percent, from about 10 percent to about 50 percent, from about 10 percent to about 40 percent, or from about 15 percent to about 25 percent by weight based on the weight of the structural layer.

Non-limiting examples of suitable organic reinforcing agents include carbon fiber, Kevlar® (“Kevlar” is a trademark of E. I. du Pont de Nemours and Company of 1007 Market Street, Wilmington, Del.), wood powder, cellulose fiber, carbon nanotubes, a starch based polymer, and combinations thereof. In any of the various embodiments of the present invention, the organic reinforcing agent concentration is no more than about 70 percent, from about 5 percent to about 60 percent, from about 10 percent to about 50 percent, from about 10 percent to about 40 percent, or from about 15 percent to about 25 percent by weight based on the weight of the structural layer.

In any of the various embodiments of the present invention wherein the structural layer optionally comprises reinforcing agent and color concentrate, the concentration of general purpose PS is less than about 50 percent, less than about 40 percent, less than about 30 percent, less than about 20 percent, less than about 10 percent, less than about 1 percent, and ranges thereof by weight based on the weight of the structural layer, the HIPS concentration is from about 10 percent to about 95 percent, from about 20 percent to about 90 percent, from about 30 percent to about 85 percent, from about 40 percent to about 80 percent, from about 50 percent to about 75 percent, from about 60 percent to about 70 percent, or from about 65 percent to about 70 percent by weight based on the weight of the structural layer, the reinforcing agent concentration is from about 0 percent to about 70 percent, from about 5 percent to about 60 percent, from about 10 percent to about 50 percent, from about 15 percent to about 40 percent, from about 20 percent to about 35 percent, or from about 25 percent to about 30 by weight based on the weight of the structural layer, and the color concentrate concentration is from about 0 percent to about 10 percent, from about 1 percent to about 10 percent, from about 2.5 percent to about 7.5 percent, or from about 3 percent to about 5 percent by weight based on the weight of the structural layer.

In any of the various embodiments of the present disclosure, the structural layer thickness is from about 0.2 mm to about 3.175 mm, from about 0.3 mm to about 2.5 mm, from about 0.4 mm to about 2.0 mm, from about 0.5 mm to about 1.5 mm, from about 0.75 mm to about 1.25 mm, or from about 0.9 mm to about 1.1 mm.

### Moisture Barrier Layer

The moisture barrier layer comprises a polymer component comprising at least one cyclic olefin copolymer (COC). As used herein, the term “cyclic olefin copolymer” refers to copolymers formed from at least one alpha-olefin co-monomer and at least one cyclic aliphatic co-monomer. For example, COC described herein may be formed from an ethylene monomer and a co-monomer such as norbornene, substituted norbornene, cyclopentene, substituted cyclopentene, cyclobutene, cyclopentene, methylcyclopentene, 5-vinylnorbornene, 5-methylnorbornene, 5-ethylidenorbornene, dicyclopentadiene, tetracyclododecene, cyclododecatriene, and combinations. In some embodiments, the polymer is formed from an ethylene monomer and a norbornene co-monomer. In yet other embodiments, the polymer component of the moisture barrier layer consists essentially of COC.

In some embodiments, the polymer component of the moisture barrier layer may comprise a blend of at least one COC and at least one polyolefin (PO). Examples of suitable PO include, but are not limited to, low density polyethylene, linear low density polyethylene, high density polyethylene, medium density polyethylene, very low density polyethylene, blends thereof, polypropylene homopolymer or random copolymer, blends thereof, polymethylpentene, polybutene-1, polyisobutylene, polybutadiene, polyisoprene, and combinations thereof. In yet other embodiments, the polymer component of the moisture barrier layer consists essentially of COC and PO.

In any of the various embodiments of the present invention, the COC concentration is at least 10 percent, at least 20 percent, at least 30 percent, at least 40 percent, at least 50 percent, at least 60 percent, at least 70 percent, at least 80 percent, at least 90 percent, about 100 percent, and ranges thereof, by weight based on the weight of the polymer component of the moisture barrier layer. Further, the polyolefin concentration is less than 90 percent, less than 80 percent, less than 70 percent, less than 60 percent, less than 50 percent, less than 40 percent, less than 30 percent, less than 20 percent, less than 10 percent, about 0 percent, and ranges thereof, by weight based on the weight of the polymer component of the moisture barrier layer. In some embodiments, the cyclic olefin copolymer concentration is greater than about 30 percent by weight based on the weight of the polymer component of the moisture barrier layer. In some other embodiments, the weight ratio of the cyclic-olefin-copolymer to the polyolefin is from about 1:1 to about 1:3, from about 1:1 to about 1:2, about 1:1, from about 2:1 to about 1:1, from about 3:1 to about 1:1, from about 5:1 to about 1:1, from about 5:1 to about 2:1, from about 10:1 to about 1:1, from about 10:1 to about 5:1, from about 20:1 to about 1:1, from about 50:1 to about 1:1, or from about 100:1 to about 1:1.

The COC preferably has a glass transition temperature (T_{g}) suitable to allow for processing by extrusion and thermoforming For example, COC may have a T_{g} of from about 65° C. to about 178° C., or from about 66° C. to about 150° C., or from about 68° C. to about 125° C., or from about 70° C. to about 100° C., or from about 75° C. to about 80° C. In some embodiments, the COC used herein has a T_{g} of about 78° C.

In some embodiments, the moisture barrier layer may further comprise reinforcing fillers such as an inorganic reinforcing agent and/or an organic reinforcing agent, and active/passive oxygen scavengers. Examples of suitable inorganic reinforcing agents (IRA) include, but are not limited to, talc, calcium carbonate, wollastonite, aragonite, mica, nanoclay, silica, glass fiber, and combinations thereof. Examples of suitable organic reinforcing agents include, but are not limited to, carbon fiber, Kevlar®, wood powder, cellulose fiber, a starch based polymer, and combinations thereof. In any of the various embodiments of the present invention, the reinforcing agent concentration is no more than about 70 percent, from about 5 percent to about 60 percent, from about 10 percent to about 50 percent, from about 10 percent to about 40 percent, or from about 15 percent to about 25 percent by weight based on the weight of the structural layer.

In any of the various embodiments of the present disclosure, the moisture barrier layer thickness is from about 0.01 mm to about 0.25 mm, from about 0.035 mm to about 0.2 mm, from about 0.05 mm to about 0.15 mm, from about 0.06 mm to about 0.1 mm, or from about 0.7 mm to about 0.9 mm.

### Oxygen Barrier Layer

The multilayer structures of the present invention may optionally further comprise one or more oxygen barrier layers. The oxygen barrier layer may comprise any suitable thermoplastic polymer having oxygen barrier and/or oxygen scavenging properties that enables the multi-layer sheet structure to function as described herein. Examples of suitable thermoplastic polymers include, but are not limited to, poly(ethylene vinyl alcohol) (EVOH), polyvinyl alcohol (PVOH), polyvinylidene chloride (PVDC), polychlorotrifluoro ethylene (PCTFE), liquid crystalline polymer (LCP), polyamide, acrylate copolymers, and combinations thereof

In some embodiments, the oxygen barrier layer may further comprise agents (fillers) that improve the oxygen barrier performance properties such as, but not limited to, active/passive oxygen scavengers, nanofillers including talc, glass, clay, silica, mica, halloysite nanotubes, nanoclays, silicon dioxide, calcium carbonate, cellulose nanofibers, and combinations thereof. Further, the oxygen barrier layer may comprise a metalized material, a metal foil, and/or a coating composition comprising an oxide such as SiOₓ, AlOₓ, and the like.

In some other embodiments, the oxygen barrier layer can be formed from polymers having limited oxygen barrier capabilities (such as polypropylene (PP) or polyethylene (PE)) that is co-formulated or co-formed with any of the above disclosed agents that improve oxygen barrier performance.

In any of the various embodiments of the present disclosure, the oxygen barrier layer thickness is from about 0.0075 mm to about 0.15 mm, from about 0.01 mm to about 0.1 mm, from about 0.015 mm to about 0.075 mm, from about 0.02 mm to about 0.05 mm, or from about 0.0225 mm to about 0.03 mm.

### Polyolefin Layer

The multilayer structures of the present invention may optionally further comprise one or more PO layers. The PO layer may comprise any suitable PO that enables the multi-layer sheet structure to function as described herein. Non-limiting examples of suitable PO include low density polyethylene (“LDPE”), linear low density polyethylene, high density polyethylene, medium density polyethylene, very low density polyethylene, ethyl vinyl acetate, polypropylene, a polypropylene homopolymer or copolymer, polymethylpentene, polybutene-1, polyisobutylene, polybutadiene, polyisoprene, and combinations or blends thereof

In any of the various embodiments of the present disclosure, the polyolefin layer thickness is from about 0.012 mm to about 0.25 mm, from about 0.035 mm to about 0.2 mm, from about 0.05 mm to about 0.15 mm, from about 0.06 mm to about 0.1 mm, or from about 0.7 mm to about 0.9 mm.

### Tie Layer

The multilayer structures of the present invention may optionally comprise one or more tie layers positioned between dissimilar layers that function to bind those layers thereby forming a multilayer structure that is resistant to layer delamination. For instance, a tie layer can serve to (i) bind a structural layer to a moisture barrier layer, an oxygen barrier layer, or a PO layer, (ii) bind a moisture barrier layer to an oxygen barrier layer or a PO layer, or (iii) bind an oxygen barrier layer to a PO layer.

The tie layer may comprise any suitable material that enables the multi-layer sheet structure to function as described herein. Examples of suitable tie layer materials include, but are not limited to maleic anhydride grafted polypropylene, polyethylene, a functionalized polyethylene material, ethylene vinyl acetate, a functionalized polypropylene, a polypropylene copolymer, polyamide, a functionalized polyolefin material, and blends of polyethylene and polypropylene comprising active groups such as epoxy, glycidyl, and combinations thereof, that are capable of reacting with the material of the structural, moisture barrier, oxygen barrier and PO layers.

In any of the various embodiments of the present disclosure, the tie layer thickness is from about 0.0075 mm to about 0.15 mm, from about 0.01 mm to about 0.1 mm, from about 0.0125 mm to about 0.075 mm, from about 0.015 mm to about 0.05 mm, or from about 0.0175 mm to about 0.025 mm.

### Multi-Layer Sheet Structure

The multi-layer sheet structure may comprise any suitable combination and number of layers that enables the multi-layer sheet structure to function as described herein. For example, structural, polyolefin, moisture barrier, structural with reinforcing agent, oxygen barrier, and adhesive tie layers may be arranged in any suitable combination that enables the multi-layer sheet structure to function as described herein.

Non-limiting examples of multilayer embodiments of the present invention are shown as A through O in Table 1 wherein “a” represents a structural layer as described above, “b” represents a polyolefin layer as described above, “c” represents a moisture barrier layer as described above, “d” represents a structural layer with reinforcing agent as described above, “e” represents an oxygen barrier layer as described above, and “f” represents a tie layer as described above.

In some embodiments, and as shown by the sheet structures A-O in Table 1, the multi-layer sheet structure may comprise at least three (3) layers, and may comprise up to eleven (11) layers of thermoplastic polymers. In the exemplary embodiments, the multi-layer sheet structure comprises a structural layer and a moisture barrier layer. Optionally, the multi-layer sheet structure may comprise an oxygen barrier layer, tie layers to couple the oxygen barrier layer to adjacent layers, and/or a polyolefin layer to provide additional structure to the multi-layer sheet structure. Further, the layers of the multi-layer sheet structure may be arranged in any suitable formation and is not limited to the formations of structures A-O.

TABLE 1

| Layer | A | B | C | D | E | F | G | H | I | J | K | L | M | N | O |
|---|---|---|---|---|---|---|---|---|---|---|---|---|---|---|---|
| 1 | a | d | a | d | a | a | d | d | a | a | a | c | a | b | a |
| 2 | f | f | f | f | f | f | f | f | d | d | f | f | f | c | d |
| 3 | c | c | c | c | e | e | e | e | f | f | e | d | e | f | f |
| 4 | | | b | b | f | f | f | f | e | e | f | f | f | d | e |
| 5 | | | | | c | c | c | c | f | f | a | e | a | f | f |
| 6 | | | | | | b | | b | c | c | f | f | f | e | b |
| 7 | | | | | | | | | | b | c | d | c | f | c |
| 8 | | | | | | | | | | | | f | b | d | b |
| 9 | | | | | | | | | | | | c | | f | |
| 10 | | | | | | | | | | | | | | c | |
| 11 | | | | | | | | | | | | | | b | |

As shown in Table 1, Composition A comprises, in series, a structural layer, a tie layer, and a moisture barrier layer. Composition B comprises, in series, a structural layer with reinforcing fiber, a tie layer, and a moisture barrier layer. Composition C comprises, in series, a structural layer, a tie layer, a moisture barrier layer, and a polyolefin layer. Composition D comprises, in series, a structural layer with reinforcing fiber, a tie layer, a moisture barrier layer, and a moisture barrier layer. Composition E comprises, in series, a structural layer, a first tie layer, an oxygen barrier layer, a second tie layer, and a moisture barrier layer. Composition F comprises, in series, a structural layer, a first tie layer, an oxygen barrier layer, a second tie layer, a moisture barrier layer, and a polyolefin layer. Composition G comprises, in series, a structural layer with reinforcing agent, a first tie layer, an oxygen barrier layer, a second tie layer, and a moisture barrier layer. Composition H comprises, in series, a structural layer with reinforcing agent, a first tie layer, an oxygen barrier layer, a second tie layer, a moisture barrier layer, and a polyolefin layer. Composition I comprises, in series, a structural layer, a structural layer with reinforcing agent, a first tie layer, an oxygen barrier layer, a second tie layer, and a moisture barrier layer. Composition J comprises, in series, a structural layer, a structural layer with reinforcing agent, a first tie layer, an oxygen barrier layer, a second tie layer, a moisture barrier layer, and a polyolefin layer. Composition K comprises, in series, a first structural layer, a first tie layer, an oxygen barrier layer, a second tie layer, a second structural layer, a third tie layer, and a moisture barrier layer. Composition L comprises a first moisture barrier layer, a first tie layer, a first structural layer with reinforcing agent, a second tie layer, an oxygen barrier layer, a third tie layer, a second structural layer with reinforcing agent, a fourth tie layer, and a second moisture barrier layer. Composition M comprises, in series, a first structural layer, a first tie layer, an oxygen barrier layer, a second tie layer, a second structural layer, a third tie layer, a moisture barrier layer, and a polyolefin layer. Composition N comprises, in series, a first polyolefin layer, a first moisture barrier layer, a first tie layer, a first structural layer with reinforcing agent, a second tie layer, an oxygen barrier layer, a third tie layer, a second structural layer with reinforcing agent, a fourth tie layer, a second moisture barrier layer, and a second polyolefin layer. Composition O comprises, in series, a structural layer, a structural layer with reinforcing agent, a first tie layer, an oxygen barrier layer, a second tie layer, a first polyolefin layer, a moisture barrier layer, and a second polyolefin layer.

In any of the various embodiments of the present invention, the multi-layer sheet structure thickness is from about 0.25 mm to about 4.0 mm, from about 0.5 mm to about 3.0 mm, from about 0.75 mm to about 2.0 mm, from about 0.9 mm to about 1.5 mm, or from about 1.0 mm to about 1.25 mm.

In any of the various embodiments of the present invention, the multi-layer sheet structures have moisture barrier properties characterized as having a moisture vapor transmission rate (MVTR) of less than about 0.03 g/pkg/day, less than about 0.025 g/pkg/day, less than about 0.02 g/pkg/day, less than about 0.015 g/pkg/day, less than about 0.01 g/pkg/day or less than about 0.005 g/pkg/day, and ranges thereof, such as from about 0.002 to about 0.03 g/pkg/day, from about 0.005 to about 0.02 g/pkg/day, or from about 0.01 to about 0.02 g/pkg/day, where “pkg” refers to a package or a container. Non-limiting examples of packages include containers configured to store moisture sensitive products such as, but not limited to reconstitutable food products such as broth, soup, coffee, tea, cocoa, chocolate, apple cider or powdered drinks. As such, the multi-layer sheet structures of the present invention provide for an MVTR of about 10%, about 20%, about 30%, about 40%, about 50%, about 60%, about 70% or about 80%, and ranges thereof, such as from about 10% to about 80%, from about 20% to about 80%, from about 30% to about 70% or from about 30% to about 60% of the MVTR for comparative similarly constructed multi-layer compositions differing with respect to (i) having a polyolefin layer instead of a moisture barrier layer or (ii) having a polyolefin layer instead of a moisture barrier layer and having a structural layer comprising IRA.

Embodiments including at least one structural layer comprising an IRA may be further characterized as having reduced environmental impact (expressed as kg of carbon dioxide equivalents per container formed from the multi-layer compositions) and reduced container forming energy requirements (expressed as Joules per gram of a container formed from the multi-layer compositions) as compared to a similar container formed from a similarly constructed multi-layer composition not having a structural layer comprising IRA. Such IRA-containing multi-layer sheet structures provide for a relative kg CO₂/kg value of about 70%, about 75%, about 80%, about 85%, about 90% or about 95%, and ranges thereof, such as from about 70% to about 95%, from about 75% to about 90% or from about 80% to about 85%, of the kg CO₂/kg of a similar container formed from a comparative similarly constructed multi-layer composition differing with respect to a structural layer not comprising IRA and having a polyolefin layer instead of a moisture barrier layer. Such IRA-containing multi-layer sheet structures provide for a container forming energy requirement of about 40%, about 50%, about 60%, about 70%, about 80% or about 90%, and ranges thereof, such as from about 40% to about 90%, from about 40% to about 80% or from about 40% to about 70%, of the kg CO₂/kg of a similar container formed from a comparative similarly constructed multi-layer composition differing with respect to a structural layer not comprising IRA and having a polyolefin layer instead of a moisture barrier layer.

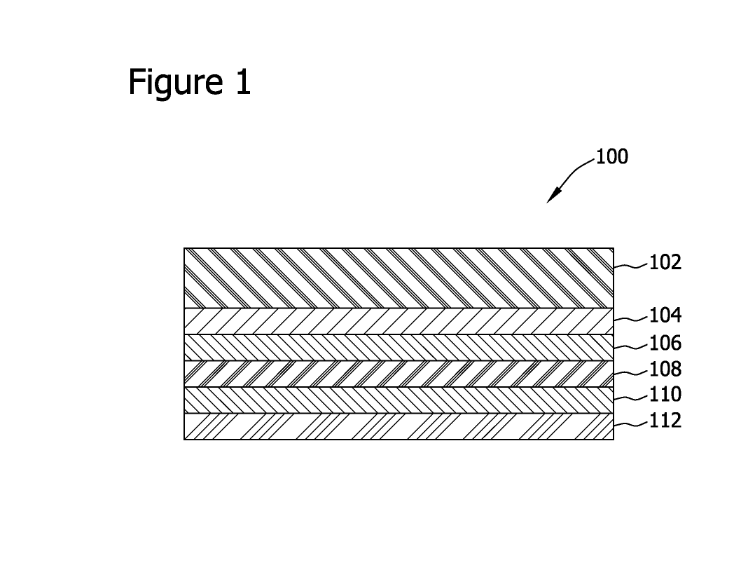

Referring now to FIG. 1, a multi-layer sheet structure 100 in accordance with either structure F or H is shown. In the exemplary embodiment, multi-layer sheet structure comprises at least one structural layer 102 and at least one moisture barrier layer 110. More specifically, multi-layer sheet structure comprises, in series, structural layer 102, a first tie layer 104, an oxygen barrier layer 106, a second tie layer 108, moisture barrier layer 110, and a polyolefin layer 112. As such, in the exemplary embodiment, oxygen barrier layer 106 is positioned between structural layer 102 and moisture barrier layer 110, first tie layer 104 is positioned between structural layer 102 and oxygen barrier layer 106, and second tie layer 108 is positioned between oxygen barrier layer 106 and moisture barrier layer 110.

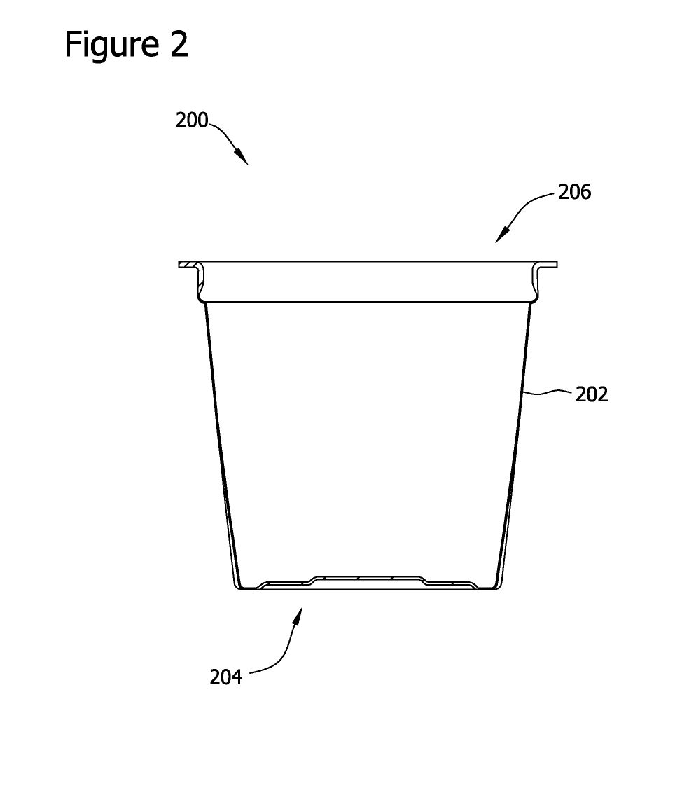

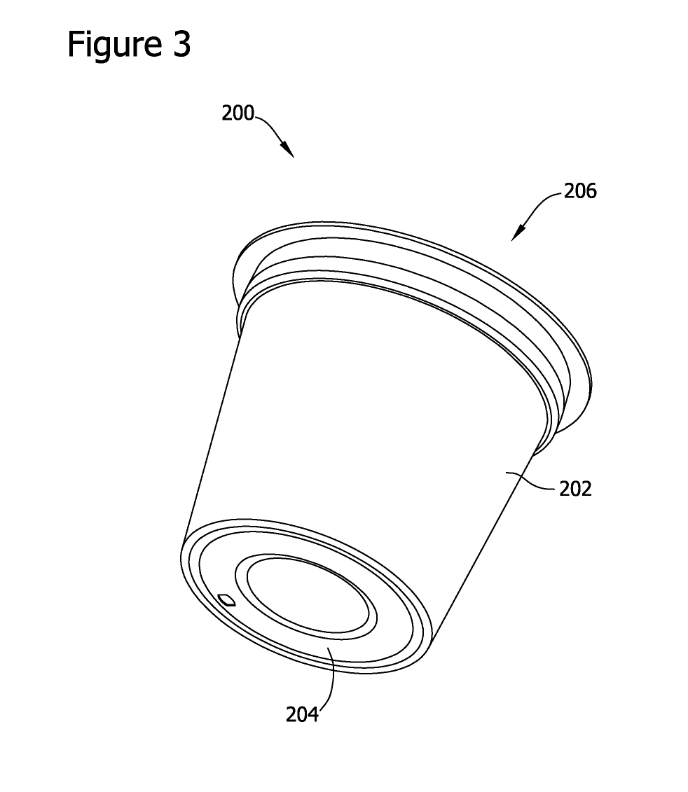

FIG. 2 is a perspective view of a container 200 formed from multi-layer sheet structure 100, and FIG. 3 is a side view of container 200. In the exemplary embodiment, container 200 comprises a side wall 202, a bottom wall 204 coupled to side wall 202, and an open end 206 opposite bottom wall 204.

### Method of Making the Multi-Layer Sheet Structure

A method of making the multi-layer sheet structure is also described herein. The multi-layer sheet structure may be made by a co-extrusion process with transfer tubes, a feedblock combined with or without a multi-manifold die, and a plurality of extruders. In some embodiments, the method comprises feeding a plurality of thermoplastic materials to the plurality of extruders, and co-extruding the plurality of thermoplastic materials from the plurality of extruders to form a plurality of layers.

The multi-layer sheet structure may also be made by combining a co-extrusion and a lamination and/or blown film process. For example, and with regard to structure O, the structural layer, the structural layer with reinforcing agent, the first tie layer, the oxygen barrier layer, and the second tie layer may be co-extruded at the nip roll forming a first sheet structure. Separately, the first polyolefin layer, the moisture barrier layer, and the second polyolefin layer may be co-extruded forming a second sheet structure. The second sheet structure may then be laminated to the first sheet structure thereby forming structure O.

Alternatively, with regard to structure I, the structural layer, the structural layer with reinforcing agent, the first tie layer, the oxygen barrier layer, and the second tie layer may be co-extruded at the nip roll forming a first sheet structure. Separately, the moisture barrier layer may be extruded forming a second sheet structure. The second sheet structure may then be laminated to the first sheet structure thereby forming structure I.

### EXAMPLES

The following non-limiting simulations are provided to further illustrate the present invention.

As shown by the compositions in Table 2, three (3) containers (cups) formed from multi-layer sheet structures were produced and tested. The multi-layer sheet structure of cup STD-PS is a comparative prior art structure comprised of six (6) layers in series comprising a first structural layer, a second structural layer, a first tie layer, an oxygen barrier layer, a second tie layer, and a polyolefin layer. The multi-layer sheet structure of cup HMB of the present invention comprised six (6) layers in series comprising a first structural layer, a second structural layer, a first tie layer, an oxygen barrier layer, a second tie layer, and a moisture barrier layer. The multi-layer sheet structure of cup HMB1 of the present invention comprised six (6) layers in series comprising a first structural layer with reinforcing agent, a second structural layer with reinforcing agent, a first tie layer, an oxygen barrier layer, a second tie layer, and a moisture barrier layer. In Table 2, “a” refers to a blend of HIPS and general purpose PS, “b” refers to LDPE, “c” refers to COC containing about 65% norbornene, “d” refers to a blend of HIPS, about 4% color concentrate and about 25% inorganic reinforcing agent, “e” refers to EVOH, and “f” refers to maleic anhydride grated polyolefin (tie layer).

The first and second structural layers of cups STD-PS and HMB contained 20 percent polystyrene regrind by weight, 72 percent rubber modified polystyrene (HIPS) by weight, and 8 percent color concentrate by weight based on the weight of the structural layer. In these examples, two adjacent structural layers were formed because of equipment limitations that restricted layer thickness to a maximum of from about 0.75 to about 0.8 mm. Layer thickness in excess of about 0.75 to about 0.8 mm required the preparation of two adjacent layers having the same composition. The properties of the combination of two adjacent “a” films are believed to be equivalent to a single layer having the same thickness as the sum of two adjacent layers. The first and second structural layers with reinforcing agent of cup HMB1 contained 0 percent polystyrene by weight, 66 percent HIPS by weight, 26 percent inorganic reinforcing agent by weight, and 8 percent color concentrate by weight. The oxygen barrier layer of cups STD-PS, HMB, and HMB1 contained from about 29 percent by weight to about 32 percent by weight ethylene based on the weight of the oxygen barrier layer. The tie layer was maleic anhydride grafted polyolefin, and the moisture barrier layer of cups HMB and HMB1 had a T_{g} of 78° C.

Layer 1 of cups STD-PS and HMB had a thickness of 0.75 mm, layer 2 had a thickness of 0.2 mm, layer 3 had a thickness of 0.02 mm, layer 4 had a thickness of 0.025 mm, layer 5 had a thickness of 0.02 mm, and layer 6 had a thickness of 0.08 mm. Layer 1 of cup HMB1 had a thickness of 0.8 mm, layer 2 had a thickness of 0.01 mm, layer 3 had a thickness of 0.02 mm, layer 4 had a thickness of 0.013 mm, layer 5 had a thickness of 0.08 mm, and layer 6 had a thickness of 0.02 mm.

TABLE 2

| | STD-PS | | HMB | | HMB1 | |
|---|---|---|---|---|---|---|
| | | Thickness | | Thickness | | Thickness |
| Layer | Material | (mm) | Material | (mm) | Material | (mm) |
| 1 | a | 0.75 | a | 0.75 | d | 0.80 |
| 2 | a | 0.20 | a | 0.20 | d | 0.01 |
| 3 | f | 0.02 | f | 0.02 | f | 0.02 |
| 4 | e | 0.025 | e | 0.025 | e | 0.013 |
| 5 | f | 0.02 | f | 0.02 | f | 0.08 |
| 6 | b | 0.08 | c | 0.08 | c | 0.02 |
| Thick- | | 1.10 | | 1.10 | | 0.94 |
| ness | | | | | | |

### Moisture Vapor Transmission Testing

The three single serve brewing container (cups) designated as STD-PS, HMB, and HMB1 were prepared from multi-layer sheet structures as described above. The multi-layer sheet structures were then formed into the single serve brewing cup shape in a plug-assisted thermoforming process. The single serve brewing cups each had a surface area of about 75 cm². Thermoforming conditions were adjusted as required to improve material distribution around the lower side wall, heel, and bottom of the cups. Cups STD-PS and HMB were thermoformed at about 150° C., and cup HMB1 was thermoformed at about 140° C. Cup STD-PS did not contain a moisture barrier layer, and cups HMB and HMB1 were cups formed from multi-layer sheet structures of the present invention.

Cups STD-PS, HMB, and HMB1 were evaluated to determine the moisture vapor transmission rate (MVTR) of the cups in grams of moisture transmitted through the package over a day long period. The moisture vapor transmission testing was conducted on MOCON PARMATRAN-W 3/33 instrument as per ASTM F-1307 at 40° C. and (75±5) % relative humidity.

In the MVTR test, the containers (cups) were placed in a MOCON PERMATRAN-W 3/33 tester. The cups were placed in a test cell that separated an inner chamber of the cups from the surrounding environment. The inner chamber was filled with a nitrogen carrier gas, and the surrounding environment was saturated with a water vapor test gas. The water molecules of the water vapor test gas were allowed to diffuse through the test cups to the inner chamber, and conveyed to a modulated infrared sensor by the carrier gas. MVTR data was taken when a steady state condition was reached.

The MVTR test results are presented in Table 3 below. The cups formed from the inventive multi-layer sheet structure as described herein provided reduced moisture vapor transmission therethrough than the known configuration. Cup STD-PS had a relative MVTR of 100, cup HMB had a relative MVTR of 35, and cup HMB1 had a relative MVTR of 55.

TABLE 3

| | MVTR (g/pkg/day) |
|---|---|
| CUP | Relative |
| STD-PS | 100 |
| HMB | 35 |
| HMB1 | 55 |

Accordingly, the cups formed from the multi-layer sheet structure as described herein produced a lower moisture vapor transmission rate when compared to the cup without a moisture barrier layer. For example cups HMB and HMB1 produced a lower MVTR when compared to STD-PS by at least about 45 percent, and up to about 65 percent. Although cup HMB 1 had a greater MVTR when compared to cup HMB, the HMB1 MVTR was still lower than the STD-PS MVTR.

### Cup Puncture Testing

Cups STD-PS, HMB, and HMB1 were evaluated to determine the puncture passage rate, and puncture characteristics of the cups. To determine the puncture passage rate, at least 10 samples of each cup were produced and tested in commercially available brewing machines manufactured by Keurig®. Passage is defined as a piercing of the container bottom structure without the generation of debris that might contaminate the brewed product, e.g., a beverage. The brewing machines used were Keurig® Model B140, Keurig® Model B160, Keurig® Model B155, and Keurig® Model B3000SE.

In the puncture passage rate test, the cups were placed in the K-Cup® Assembly Housing and the Brewer Handle was lowered. By lowering the Brewer Handle, the piercing stem located in the Assembly Housing contacted the cup placed therein.

The puncture passage rate test results are presented in Table 4 below. Cup STD-PS produced a 100 percent puncture passage rate for Model B140, Model B160, Model B155, and Model B3000SE. Inventive cups HMB and HMB1 likewise produced a 100 percent puncture passage rate for Model B140, Model B160, Model B155, and Model B3000SE.

TABLE 4

| Keurig Model # | STD-PS | HMB | HMB1 |
|---|---|---|---|
| B140 | 100% | 100% | 100% |
| B160 | 100% | 100% | 100% |
| B155 | 100% | 100% | 100% |
| B3000SE | 100% | 100% | 100% |

Accordingly, the cups formed from the multi-layer sheet structure as described herein produced identical puncture passage rate results when compared to the cup without a moisture barrier layer. It is believed, without being bound by any particular theory, that the inherent high stiffness and ductile nature of impact modified cups facilitates leaving clean cuts on the cup bottoms after puncture. In contrast, cups that contain pure crystalline polystyrene would fracture into shards when punctured by the piercing stem. Further, it has been found that the moisture barrier layer of embodiments of the present invention does not adversely affect the puncture passage rate of cups formed therefrom.

In the puncture characteristics test, the cups were subjected to an instron puncture test. The cups formed from the multi-layer sheet structure as described herein exhibited puncture force and puncture depth characteristics within acceptable industry standards, and with substantially equivalent puncture force and puncture depth characteristics when compared to the cup without a moisture barrier layer. Further, cups HMB and HMB1 exhibited improved puncture force characteristics with cup HMB being punctured with less force than cup STD-PS, and cup HMB1 being punctured with less force than cup STD-PS.

### Sustainability Testing

Cups STD-PS and HMB1 were evaluated to determine the environmental impact and energy required for sheet heating/melting of the cups. In the environmental impact test, a life cycle analysis was used that accounted for the cup's materials processing, manufacture, distribution, use, repair/maintenance, and disposal/recycling during the lifetime of the cup. A CO₂ equivalent was then derived from a Life Cycle Analysis (LCA) program, for calculating environmental impact. LCA can be done by any various commercially available software programs, such as provided by Sustainable Minds®.

The relative environmental impact (% CO₂ equivalent per cup) obtained from the LCA are presented in Table 6 below.

TABLE 6

| | % of CO₂ Equivalent (kg/cup) |
|---|---|
| CUP | Relative |
| STD-PS | 100 |
| HMB1 | 83 |

Accordingly, the cup formed from the multi-layer sheet structure as described herein that comprised IRA produced a lower carbon footprint when compared to the commercially available brewing cup. For example, cup HMB1 produced a lower carbon footprint when compared to STD-PS by about 17 percent.

In the sheet heating/melting energy test, differential scanning calorimetry (DSC) was used to determine the amount of energy required for sheet heating/melting of the cups.

The sheet heating/melting energy requirement test results are presented in Table 7 below.

TABLE 7

| | Enthalpy (J/g) |
|---|---|
| CUP | Relative |
| STD-PS | 100 |
| HMB1 | 65 |

Accordingly, the cup formed from the multi-layer sheet structure as described herein that comprised IRA required less energy to heat/melt the cup when compared to the commercially available brewing cup. For example, cup HMB 1 required about 35 percent less energy when compared to STD-PS.

### Cost Analysis

The multi-layer sheet structures of cups STD-PS, HMB, and HMB 1 were evaluated to determine the price change/increase of structures HMB and HMB1 when compared to structure STD-PS. The cost of sheet structure STD-PS was determined and used as a baseline when compared to the cost of structures HMB and HMB1. HMB and HMB1 both cost more when compared to the cost of STD-PS, but the price increase of HMB1 was only about 20% of the price increase of HMB.

Accordingly, it has been found that sheets formed from structures HMB and HMB1 may be produced with marginally increased cost when compared to sheets formed from structure STD-PS. With regard to HMB1, it is believed that the loading of IRA within the layers therein provided suitable stiffness and mechanical performance for the multi-layer sheet structure while enabling the thickness of the multi-layer sheet structure to be reduced. As such, it is believed that the lower IRA costs when compared to other thermoplastic materials, the reduced thickness of the multi-layer sheet structure, and optimization of the cyclic olefin copolymer to polyolefin ratio in the moisture barrier layer resulted in the marginal increase in cost of HMB1, and may result in a more economically and/or commercially viable cup product in the market place.

As shown by the experimental results, the cups formed from the multi-layer sheet structures described herein exhibited a lower moisture vapor transmission rate, produced identical puncture passage rate results, exhibited substantially equivalent puncture force and puncture depth characteristics, produced a lower carbon footprint, required less energy to heat/melt the cup, and produced cups at marginally increased costs when compared to commercially available brewing cups. It is believed, based on the experimental evidence to date, that the combination of layers of moisture barrier and oxygen barrier materials will facilitate maintaining the freshness of contents packaged in containers formed from the multi-layer sheet structures described herein for a longer period of time when compared to commercially available brewing cups.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A multi-layer sheet structure comprising:
at least one structural layer comprising high impact polystyrene; and
at least one moisture barrier layer comprising greater than about 30 percent cyclic olefin copolymer by weight of said at least one moisture barrier layer.

2. The multi-layer sheet structure of claim 1, wherein the at least one structural layer further comprises general purpose polystyrene wherein the weight ratio of the high impact polystyrene to general purpose polystyrene is from about 10:1 to about 2:1.

3. The multi-layer sheet structure of claim 1, wherein the at least one structural layer further comprises at least one of a color concentrate, regrind, a foaming agent, an inorganic reinforcing agent, and an organic reinforcing agent.

4. The multi-layer sheet structure of claim 3, wherein the inorganic reinforcing agent comprises at least one of talc, calcium carbonate, wollastonite, aragonite, mica, nanoclay, silica, and glass fiber, and wherein the inorganic reinforcing agent concentration is from about 10 to about 40 percent by weight of the structural layer.

5. The multi-layer sheet structure of claim 3 wherein the structural layer comprises regrind and the regrind concentration is from about 10 percent to about 40 percent by weight based on the weight of the at least one structural layer.

6. The multi-layer sheet structure claim 1, wherein the at least one moisture barrier layer further comprises a polyolefin wherein the weight ratio of the cyclic olefin copolymer to the polyolefin is from about 5:1 to about 1:1.

7. The multi-layer sheet structure of claim 1 further comprising at least one oxygen barrier layer wherein the oxygen barrier layer comprises at least one of ethylene vinyl alcohol, polyvinylidene chloride, polyvinyl alcohol, polyamide, polyethylene terephthalate, a metalized material, a metal foil, a composition comprising an oxide coating, and a thermoplastic polymer comprising at least one of a calcium carbonate filler, talc filler, nanoclay filler, silicon dioxide filler, and an oxygen scavenger.

8. The multi-layer sheet structure of claim 7, wherein the at least one oxygen barrier layer is positioned between the at least one structural layer and the at least one moisture barrier layer.

9. A container comprising a side wall, a bottom wall coupled to the side wall, and an open end opposite the bottom wall, the container formed from a multi-layer sheet structure comprising:
at least one structural layer that comprises high impact polystyrene; and
at least one moisture barrier layer comprising greater than about 30 percent cyclic olefin copolymer by weight of said at least one moisture barrier layer.

10. The container of claim 9, wherein the at least one structural layer further comprises general purpose polystyrene wherein the weight ratio of the high impact polystyrene to general purpose polystyrene is from about 10:1 to about 2:1.

11. The container of claim 9, wherein the at least one structural layer further comprises at least one of color concentrate, regrind, a foaming agent, an inorganic reinforcing agent, and an organic reinforcing agent.

12. The container of claim 11, wherein the inorganic reinforcing agent comprises at least one of talc, calcium carbonate, wollastonite, aragonite, mica, nanoclay, silica, and glass fiber, and wherein the inorganic reinforcing agent concentration is from about 10 to about 40 percent by weight of the structural layer.

13. The container of claim 11, wherein the structural layer comprises regrind and the regrind concentration is from about 10 percent to about 40 percent by weight based on the weight of the at least one structural layer.

14. The container of claim 9, wherein the at least one moisture barrier layer further comprises a polyolefin wherein the weight ratio of the cyclic-olefin-copolymer to the polyolefin is from about 5:1 to about 1:1.

15. The container of claim 9 further comprising at least one oxygen barrier layer wherein the oxygen barrier layer comprises at least one of ethylene vinyl alcohol, polyvinylidene chloride, polyvinyl alcohol, polyamide, polyethylene terephthalate, a metalized material, a metal foil, a composition comprising an oxide coating, and a thermoplastic polymer comprising at least one of a calcium carbonate filler, talc filler, nanoclay filler, silicon dioxide filler, and an oxygen scavenger.

16. The container of claim 15, wherein the at least one oxygen barrier layer is positioned between the at least one structural layer and the at least one moisture barrier layer.

17. The container of claim 9, wherein a container having a surface area of about 75 cm² has a moisture vapor transmission rate of less than about 0.04 g/container/day as measured by a MOCON PARMATRAN-W 3/33 instrument as per ASTM F-1307.

18. A method of making a multi-layer sheet structure, said method comprising:
feeding a plurality of thermoplastic materials to a plurality of extruders; and
co-extruding the plurality of thermoplastic materials from the plurality of extruders to form a plurality of layers, the plurality of layers comprising:
at least one structural layer that comprises high impact polystyrene; and
at least one moisture barrier layer that comprises greater than about 30 percent cyclic olefin copolymer by weight of the at least one moisture barrier layer.

19. The method of claim 18, wherein the at least one structural layer further comprises at least one of color concentrate, regrind, a foaming agent, an inorganic reinforcing agent, and an organic reinforcing agent.

20. The method of claim 18 wherein the multi-layer sheet structure further comprises at least one oxygen barrier layer, wherein the one oxygen barrier layer is positioned between the at least one structural layer and the at least one moisture barrier layer, and wherein the oxygen barrier layer comprises at least one of ethylene vinyl alcohol, polyvinylidene chloride, polyvinyl alcohol, polyamide, polyethylene terephthalate, a metalized material, a metal foil, a composition comprising an oxide coating, and a thermoplastic polymer comprising at least one of a calcium carbonate filler, talc filler, nanoclay filler, silicon dioxide filler, and an oxygen scavenger.
